(19) United States
(12) Patent Application Publication
(10) Pub. No.: US 2006/0222824 A1
(43) Pub. Date: Oct. 5, 2006

(54) Multicolor resin molding component for mobile apparatus

(76) Inventor: Takashi Yasuhara, Ibaraki (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/545,758

(22) PCT Filed: Apr. 15, 2004
(86) PCT No.: PCT/JP04/05416

§ 371 Date: Aug. 15, 2005

(30) Foreign Application Priority Data
Apr. 25, 2003 (JP) 2003-122060

(51) Int. Cl. B41M 3/00

(52) U.S. Cl. 428/195.1

(57) ABSTRACT

To realize a more advanced and more diversified design for a keytop or ornamental member of a push-button switch by further advancing an ornamenting method used in metal plating of resin components for mobile apparatuses. A keytop or ornamental member of an intended push-button switch is formed using a multi-color resin-molding method in which different resin materials are integrally molded, and a plated film of the same metal or of different types of metals is attached to each of a plurality of regions isolated from one another on a surface of the resin component.

### TECHNICAL FIELD

The present invention relates to a technology art for ornamenting a component used for mobile apparatuses such as a portable phone and a personal digital assistant (PDA), and more particularly, to ornamenting by metal plating.

### BACKGROUND ART

Resin components for portable phones and other mobile apparatuses, such as a push-button switch keytop (operating key), come in a variety of sizes. Above all, the keytop of a multi-directional push-button switch called the “navigation key”, for example, is large-size and disposed in the center of the push-button key group, and thus the keytop is the most conspicuous component in the mobile apparatus. There are, as another example, ornamental members used to ornament various sections for improved design. For example, in a mobile apparatus with a built-in digital camera, members for ornamenting the periphery of its lens are most commonly used. Metal plating is one of important means for ornamenting such types of keytops and members.

Conventional metal-plated keytops or ornamental members, however, are each plated over the entire surface or only in a single region on the surface, and thus, these keytops or ornamental members have not evaded monotony in terms of design.

The object to be achieved by the present invention is to further advance the conventional ornamenting means used in metal plating of resin components for mobile apparatuses, and thus realize a more advanced and more diversified design.

The above object can be achieved by forming a keytop or ornamental member of a desired push-button switch by use of a multi-color resin-molding method in which different resin materials are integrally molded, and then attaching, to each of a plurality of regions isolated from one another on a surface of the resin component, a plated film of the same metal or of different types of metals.

### DISCLOSURE OF THE INVENTION

The manufacturing process for multi-color resin-molded components, pertaining to the present invention, is described below as an embodiment of the invention. FIG. 1 is a flowchart showing the manufacturing process mentioned above.

A first step in the aforementioned manufacturing process is a step of forming an original shape of a resin component to be molded. In this step, regions in which metal-plating is to be provided, and regions in which metal-plating is not to be provided, are formed of different resin materials. This step is so-called multi-color (in the present embodiment, dichromatic) resin molding. In this step, the former regions (the plating regions) are formed using, for example, an acrylonitrile-butadiene-styrene copolymer resin (ABS resin) of plating grade, and the latter regions (the non-plating regions) are formed using a material such as a polycarbonate resin (PC resin) of normal grade. In short, the regions to which a plated film is to be attached on the surface can be formed using a plating-grade resin material which permits a plated film to be easily attached, and other regions to which a plated film is not to be attached can each be formed using a different type of resin which does not allow plating in the electroless pre-plating treatment applied to the resin used in each of the regions to which a plated film is to be attached.

A plan view (A), bottom view (B), X-X line cross-sectional view (C), and Y-Y line cross-sectional view (D) of a resin-molded component produced in this first step are shown in FIG. 2, by way of example. In FIG. 2, numeral 1 denotes a keytop, numeral 2 a runner section functioning as a channel for pouring a molten material into a cavity during the molding of the keytop 1, numeral 3 a first plating region, numeral 4 a second plating region, numeral 5 a non-plating region, numeral 6 a power supply contact point for the first plating region, numeral 7 a power supply contact point for the second plating region, and numeral 8 a circular window. The non-plating region 5 is usually made transparent with or without a color, or translucent, so as to have a light-transmitting property.

That is to say, the keytop 1 is formed into a thin disc shape and, as shown in FIG. 2(A), on a surface of the keytop 1, the first plating region 3, non-plating region 5, second plating region 4, and center window 8 that are segmented by a plurality of boundary lines of a concentric shape are disposed in that order from an outer surface side of the keytop 1, towards its inner surface. Also, as shown in FIG. 2(B), on a reverse side of the keytop 1, a surface layer of a region, except for an open edge of the center window 8, is covered with PC resin and thus formed as the non-plating region 5, and the second plating region 4 formed of ABS resin has an edge bent downward at, and brought into contact with, the open edge of the above-mentioned window 8.

As shown in FIGS. 2(A), (B), and (C), the power supply contact point 6 for the first plating region is provided in the runner section 2, and the power supply contact point 7 for the second plating region is provided so as to be positioned on the reverse side of the keytop 1 and in the second plating region 4 where the open edge of the window 8 is bent downward into the reverse side of the keytop 1. The power supply contact point 6 for the first plating region and the power supply contact point 7 for the second plating region protrude in the opposite direction to each other. Although not shown in detail in the figures, the runner section 2 is also constituted by a portion formed of ABS resin and a portion formed of PC resin.

In this step, ABS resin of plating grade is selected because an electroconductive film is to be selectively attached only to a surface of the ABS resin portion by providing electroless plating as a pre-treatment step for electroplating treatment. Conversely, a surface of the PC resin portion of normal grade is not formed with an electroconductive film, even by electroless plating under the same conditions as those of the ABS resin. In this first step, a protrusion 6 and a protrusion 7, both functioning as a power supply contact point during electroplating, are integrally resin-formed in the first plating region 3 and the second plating region 4, respectively, that is separated by the non-plating region 5.

In a second step, the resin component that has been produced in the above first step is pre-treated for electroless plating. This second step comprises sub-steps of degreasing/cleaning, surface roughing, and surface catalyzing with palladium. Of these sub-steps, surface roughing (etching) is conducted using a chemical (chromic acid/sulfuric acid mixed solution without a pre-etching property) that roughs the ABS resin surface but does not affect the PC resin surface.

In a third step, an electroconductive film made of copper or nickel is selectively formed only on the ABS resin surface by electroless plating. For example, when a nickel film is to be formed, the above-mentioned resin component is immersed in a mixed solution containing 30 g/l of nickel sulfate, 20 g/l of sodium hypophosphite, and 50 g/l of di-ammonium citrate, for 5 to 10 minutes at a pH value from 8 to 9.5 and a temperature from 20 to 40° C., whereby a nickel film of 0.2 to 1.0 μm thick is formed on a surface of the resin component.

In a fourth step, a desired metal-plated film is formed by electroplating the section at which an electroconductive film has been formed on the surface of the above-mentioned resin component. This step includes a plurality of sub-steps. In these sub-steps, for example, the nickel film formed in the above third step undergoes strike nickel plating first and then copper plating, further undergoes semi-bright nickel plating and bright nickel plating, and finally undergoes decorative plating that uses chromium or the like in order to form a top layer.

Strike plating conducted first in this fourth step is intended to reinforce the nickel film formed in the above third step, and in this sub-step, a nickel film 2 to 3 μm thick is formed on the surface of the above-mentioned resin component by immersing this resin component in a mixed solution containing 240 g/l of nickel sulfate, 45 g/l of nickel chloride, and 30 g/l of boric acid, for 3 to 6 minutes at a temperature from 30 to 45° C. In the next copper-plating step, a copper film 7 to 15 μm thick is formed on the surface of the above-mentioned resin component by immersing this resin component in a mixed solution containing 200 g/l of copper sulfate, 50 g/l of sulfuric acid, and an appropriate amount of brightener as an organic additive, for 20 to 60 minutes at a temperature from 20 to 30° C. Although the above-mentioned copper plating is not necessarily conducted, this yields the effect that the attachability of nickel is improved by using copper as a base metal which is to undergo semi-bright and bright nickel plating.

In the semi-bright nickel plating step and the bright nickel plating step, the above-mentioned resin component is immersed in a mixed solution (for bright nickel plating only, with an added appropriate amount of brightener) that contains 240 g/l of nickel sulfate, 45 g/l of nickel chloride, and 30 g/l of boric acid, for 10 to 30 minutes each at a temperature from 45 to 55° C. Thus, a double-layer nickel film of 4 to 8 μm thick is formed on the surface (the thickness ratio between the semi-bright nickel-plated film and bright nickel-plated film formed is 6:4). In a chromium plating step that is finish plating, the above-mentioned resin component is immersed in a mixed solution containing 250 g/l of chromic acid, 2.5 g/l of sulfuric acid, and 1 to 3 g/l of trivalent chromium, for 1 to 3 minutes at a temperature from 45 to 55° C. A chromium film of 0.1 μm thick is thus formed on the surface. Trivalent chromium is used in the above-mentioned mixed solution to protect the environment and, as the metal allergic countermeasures described later, to avoid using harmful hexavalent chromium.

Also, the reason why the nickel-plated film becoming the underfilm for chromium plating is formed as a double-layered film by semi-bright and bright nickel plating, is that the brightener added to the mixed solution in order to form a bright nickel film provides brightness by impeding the growth of a crystal on the electrodeposition surface and microstructuring the crystal. Bright nickel plating is required as the underfilming step for chromium plating, but in terms of corrosion resistance, such nickel plating is inferior to semi-bright nickel plating that uses a plating solution to which a brightening agent is not added. The reason is that the sulfur component in the brightener co-precipitates with the nickel and deteriorates corrosion resistance.

Preferably, so-called “decorative plating” is used to form the top layer in the above fourth step. Decorative plating is likely to use, besides general chromium, a noble metal of gold, platinum, palladium, rhodium, or silver, or use titanium, copper, zinc, various alloy, or the like. By combining these metals, as appropriate, for each plating region of the keytop or ornamental member pertaining to the present invention, color and texture can be varied for each plating region.

In addition, among the plating metals for the formation of the above-mentioned top layer, zinc, nickel, silver, copper, copper alloys, and the like can be colored by immersing each of these metals in a special dyeing solution, creating a chemically converted film in a special sulfide bath, or providing electrodeposition filming. Accordingly, by coloring each of the above metals with a metallic texture being retained, the design for the keytop or ornamental member can be diversified. After coloring of the plating metals, it is desirable that surface filming with UV-cured resin be performed for surface protection.

By the way, since two or more types of metals come into contact during the plating operations performed in each sub-step of the above fourth step, it is necessary, when performing these operations, to consider the properties created from both metals, in addition to the properties of each metal. Nickel plating, for example, is excellent in uniform electrodeposition characteristics, creates few pinholes, and has a very excellent base-protecting capability. Therefore, nickel plating is widely used as underfilming for decorative plating. However, allergies ascribable to several types of metals, including nickel, are becoming a problem in recent years since the perspiration and body fluids of a user ionize these metals, causing the metals to come out in a dissolved condition on the surface, and changing each metal into an allergen. Metals which cause allergies of this type include nickel, cobalt, chromium (hexavalent chromium only) etc., and a metal allergy caused by nickel whose consumption is the largest of the above causative metals is currently prevailing. When incorporating metal-allergic countermeasures into a mobile apparatus resin component pertaining to the present invention, it is desirable that nickel or other metals causing a metal allergy should not be used for underfilming or topfilming.

In this fourth step, power is supplied to one plating region and each of other plating regions separated by a non-plating region, independently or simultaneously, via respective power supply contact points. In this case, when conducting a plating operation with the same type of metal in all of the plurality of plating regions, simultaneous supply of power is suitable, whereas, when conducting a plating operation with a different type of metal for each region, power needs to be supplied in different timing by use of a plating liquid associated with the type of metal used. Since a plated film is usually constructed by piling a number of types of films on one another as described above, it becomes necessary to select and combine the appropriate power-supplying methods and plating liquids according to the particular construction of the film.

It should be noted that after having its first plating region 3 and its second plating region 4 plated, the keytop 1, as shown in FIGS. 3(A) and 3(B), is separated from the runner section 2 and the power supply contact point 7 for the second plating region, provided on the reverse side, is also removed (similarly to the embodiments described later, the non-plating region 5 is crosshatched).

### BRIEF DESCRIPTION OF THE DRAWINGS

FIG. 1 is a flowchart showing the manufacturing process as an embodiment of the present invention;

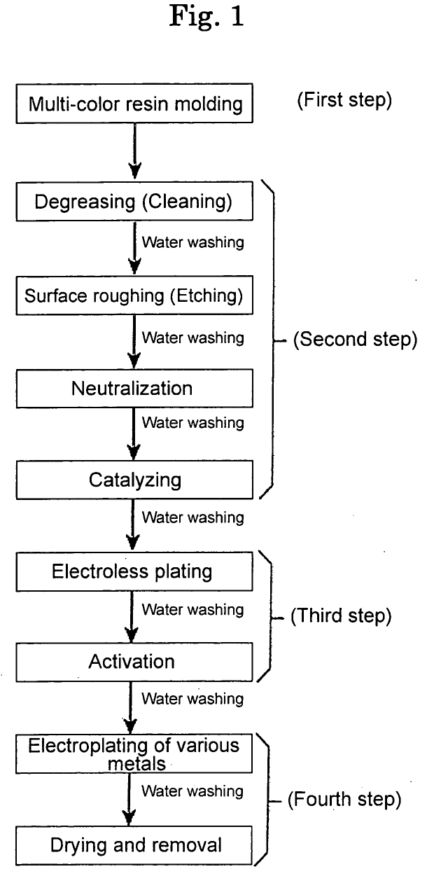

FIG. 2 is a plan view and cross-sectional view showing a resin-molded component produced in the manufacturing process of FIG. 1;

FIG. 3 is a plan view and side view of a keytop produced by removing the runner section and each power supply contact point from the resin-molded component shown in FIG. 2; and

FIG. 4 is a plan view showing six examples of the present invention.

### BEST MODE FOR CARRYING OUT THE INVENTION

### Embodiments

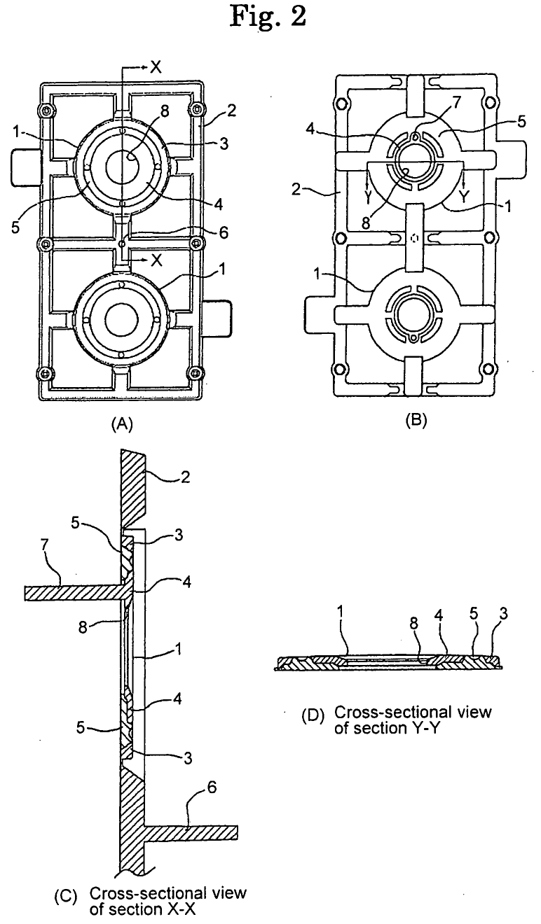

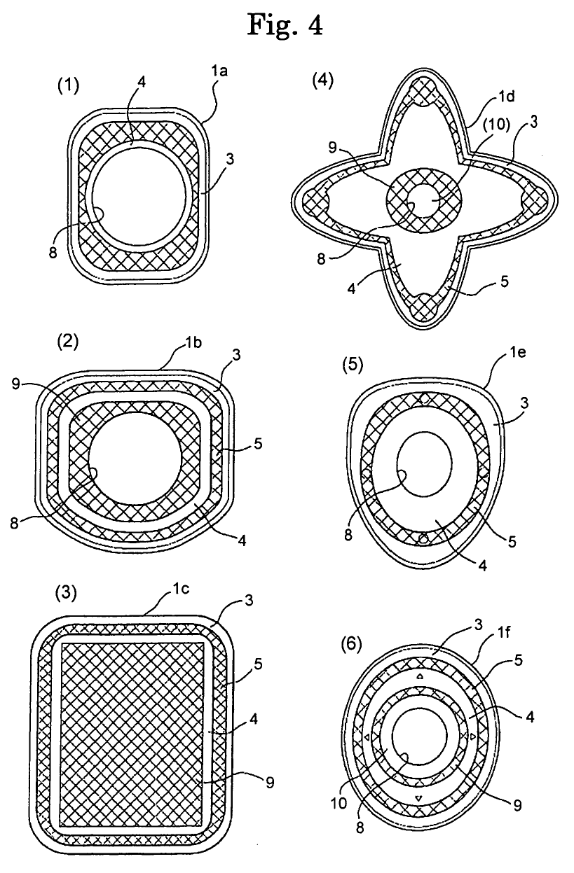

In FIG. 4, six figures that show examples of mobile apparatus resin components are shown as six preferred examples (other than those shown in FIG. 2) of the present invention. Numerals 1a, 1b, 1c in (1) to (3) denote ornamental members by way of example, and numerals 1d, 1e, 1f in (4) to (6) denote keytops of push-button switches by way of example. The crosshatched sections in each figure denote non-plating regions, and the white-core sections denote plating regions. Basically, among the circles (or ellipses) shown in the center, those surrounded by a plating region are windows, and those surrounded by a non-plating region are plating regions (or windows).

The ornamental members 1a and 1b shown in (1) and (2) of FIG. 4 are both used, for example, to ornament a periphery of a lens in a mobile apparatus having a built-in digital camera. The ornamental member 1a has a double-layer plating region isolated by one non-plating region, and includes, from an outer surface to an inner surface in order, a first plating region 3, a non-plating region 5, a second plating region 4, and a center window 8. The ornamental member 1b has a double-layer plating region isolated by a double-layer non-plating region, and includes, from an outer surface to an inner surface in order, a first plating region 3, a (first) non-plating region 5, a second plating region 4, a (second) non-plating region 9, and a center window 8.

The ornamental member 1c shown in (3) of FIG. 4 has a double-layer plating region isolated by a double-layer non-plating region, and is used, for example, to cover and protect a front face of a liquid-crystal display panel or of a lens of a digital camera, in a mobile apparatus. The ornamental member 1c consists of, from an outer surface to an inner surface in order, a first plating region 3, a (first) non-plating region 5, a second plating region 4, and an almost rectangular (second) non-plating region 9. This ornamental member 1c is made colorless or transparent which is almost colorless, thus ensuring that a display made on the liquid-crystal panel is viewed through the non-plating region 9 or that photographing is not obstructed by the lens.

The keytop 1d shown in (4) of FIG. 4 has a double-layer (or triple-layer) plating region isolated by a double-layer non-plating region, and includes, from an outer surface to an inner surface in order, a first plating region 3, a (first) non-plating region 5, a second plating region 4, a (second) non-plating region 9, and a center window 8. At the above-mentioned keytop 1d, the region in the center can be a third plating region, not the window 8.

The keytop 1e shown in (5) of FIG. 4 has a double-layer plating region isolated by one non-plating region, and includes, from an outer surface to an inner surface in order, a first plating region 3, a non-plating region 5, a second plating region 4, and a center window 8.

The keytop 1f shown in (6) of FIG. 4 has a triple-layer plating region isolated by a double-layer non-plating region, and includes, from an outer surface to an inner surface in order, a first plating region 3, a (first) non-plating region 5, a second plating region 4, a (second) non-plating region 9, a third plating region 10, and a window 8 forming a central portion. (1), (2), (3), and (5) are examples in which a double-layer plating region is provided, (4) and (6) are examples in which a triple-layer plating region is provided.

When the above-mentioned keytop 1d, 1e, or 1f is used as a large-size multi-directional push-button switch such as a navigation key, the window 8 of the keytop is generally used to dispose a trifle small, independent keytop for a so-called “confirmation key” inside the window.

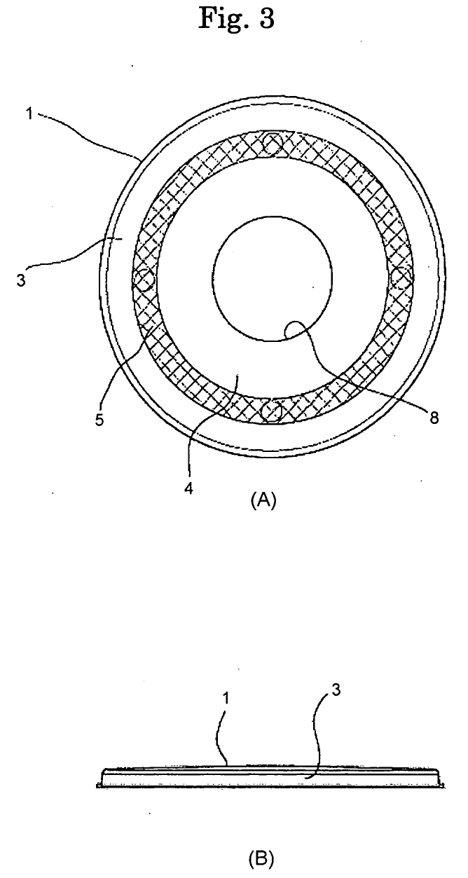

As with the ornamental member and keytop shown in FIG. 3, even for resin-molded components each having two, three, or more plating regions, by providing a power supply contact point for each of the plating regions isolated from one another on the surface, it is possible to attach, to each plating region, a plated film of the same metal or of different types of metals.

In addition, the above-mentioned ornamental members 1b and 1c and keytops 1d and if each have a plurality of non-plating regions. For these ornamental members 1b, 1c and keytops 1d, 1f, therefore, by changing the color of resin for each non-plating region as well as by combining a plurality of plating regions and non-plating regions or, as described earlier herein, providing in each plating region a plating treatment with a different type of metal (preferably, with a metal of a different color or texture), it becomes possible to create a more diversified design and thus to obtain a fresh design not achievable with the conventional art.

### INDUSTRIAL APPLICABILITY

According to the present invention of claim 1, a mobile-apparatus multi-color resin-molded component in which a plated film of the same metal or of different types of metals is attached to each of a plurality of plating regions isolated from one another on a surface of the above-mentioned resin-molded component is provided, whereby a more advanced and more diversified component design is achieved. Accordingly, the mobile apparatus improves in visual attractiveness and in the ease of use and can thus be expected to increase in demand.

According to the invention of claim 2, regions to each of which a plated film is to be attached on the surface are each formed using a plating-grade resin material which permits a plated film to be easily attached, and other regions are each formed using a resin material which does not allow plating in an electroless pre-plating step applied to the resin used in each of the regions to which a plated film is to be attached. Therefore, plating only in the regions to which a plated film is to be attached can be selectively conducted just by performing the above-mentioned plating step applied to the resin used in each of the regions to which a plated film is to be attached.

According to the invention of claims 3 and 4, a push-button switch keytop or ornamental member in which a plated film of the same metal or of different types of metals is attached to a plurality of plating regions isolated from one another on a surface of the above-mentioned keytop or ornamental member is provided. Thus, an advanced and diversified design can be assigned to a mobile apparatus.

According to the invention of claim 5, electroplating in a plurality of regions to which a plated film is to be attached is accomplished by supplying power via power supply contact points for each plating region. Accordingly, it becomes possible to supply power even in a region where power normally cannot be supplied, and consequently to perform the above-mentioned plating step with different types of metals or with the same metal.

1. A multi-color resin-molded component for mobile apparatuses, formed by integrally molding different types of resin materials, wherein a plated film of the same metal or of different types of metals is attached to each of a plurality of regions isolated from one another on a surface of said component.

2. The multi-color resin-molded component for mobile apparatuses according to claim 1, wherein a plurality of regions to each of which a plated film is attached are each formed of plating-grade resin which permits a plated film to be easily attached, and other regions are each formed using a different type of resin that does not permit plating during an electroless plating pre-treatment step applied to the resin used in each of the regions to which a plated film is attached.

3. The multi-color resin-molded component for mobile apparatuses according to claim 1, wherein the multi-color resin-molded component is used as a keytop of a push-button switch for performing various operations.

4. The multi-color resin-molded component for mobile apparatuses according to claim 1, wherein the multi-color resin-molded component is used as an ornamental member that enhances design quality of the mobile apparatus by ornamenting various sections thereof.

5. The multi-color resin-molded component for mobile apparatuses according to claim 2, wherein electroplating in a plurality of regions to each of which a plated film is to be attached is accomplished by supplying power using a power supply contact point provided in each of the regions.

6. The multi-color resin-molded component for mobile apparatuses according to claim 2, wherein the multi-color resin-molded component is used as a keytop of a push-button switch for performing various operations.

7. The multi-color resin-molded component for mobile apparatuses according to claim 2, wherein the multi-color resin-molded component is used as an ornamental member that enhances design quality of the mobile apparatus by ornamenting various sections thereof.
